(19) United States
(12) Patent Application Publication
(10) Pub. No.: US 2015/0216211 A1
(43) Pub. Date: Aug. 6, 2015

(54) FOOD COMPOSITION INCLUDING A MIXTURE OF MILK PERMEATE AND VEGETABLE MEAL

(71) Applicants: Eric Taillan, Gif Sur Yvette (FR); Anita Garem, Dampierre Sur Avre (FR); Gislene Da Silva, Viry Chatillon (FR); Amandine Bonnotte, Montargis (FR)

(72) Inventors: Eric Taillan, Gif Sur Yvette (FR); Anita Garem, Dampierre Sur Avre (FR); Gislene Da Silva, Viry Chatillon (FR); Amandine Bonnotte, Montargis (FR)

(73) Assignee: COMPAGNIE GERVAIS DANONE, Paris (FR)

(21) Appl. No.: 14/422,771

(22) PCT Filed: Aug. 21, 2012
(86) PCT No.: PCT/FR2012/051915

§ 371 Date: Feb. 20, 2015

(51) Int. Cl. A23L 1/29; A23L 1/187

(52) U.S. Cl. CPC A23L 1/29; A23L 1/187; A23V 2002/00

(57) ABSTRACT

The invention relates to a food composition comprising, in weight percent relative to the total weight of the composition:
0.5% to 5%, preferably 1% to 2%, more preferably 1% to 1.5%, and most preferably 1.2% of vegetable flour;
6% to 20%, preferably 6% to 10%, more preferably 8% to 10%, and most preferably 9.1% of milk permeate;
   characterized in that said composition has a viscosity, measured using the Rheomat RM 200 apparatus at a temperature of 10° C. and with a shearing of 64 s⁻¹, of between 200 and 4000 mPa·s, preferably between 300 and 3700 mPa·s, preferably between 400 and 3000 mPa·s, more preferably between 1000 and 2500 mPa·s, and most preferably around 2500 mPa·s.

The present invention relates to food compositions, in particular dessert-type compositions, comprising a mixture of vegetable flour and milk permeate, with a low fat content and having organoleptic and rheological properties similar to cream puddings. The invention also relates to a process for preparing such food compositions.

The food-processing industry, just like any other industry, is constantly looking for products which comply with the regulatory requirements satisfying consumer requirements, and which are affordable for the greatest number of consumers.

Reducing the fat content in food products, while at the same time preserving their organoleptic properties and their texture, has become a major and ambitious challenge for the food-processing industry. This is because consumers are today increasingly concerned about nutrition and the potential benefits of foods. They are thus looking for low-fat products which, however, provide a feeling of satiety.

Now, the reduction in the fat content in food products, in particular dairy products, is often associated with a loss of organoleptic quality and a viscosity decrease of said products, making them unsuitable for consumption or unsatisfactory given consumer requirements.

There is therefore a need for a food composition which satisfies consumer requirements and the recommendations of nutritionists.

The problem addressed by the invention is therefore that of providing a food composition comprising a low fat content, while maintaining at least the specific rheological properties of dairy products, in particular of cream puddings, and while retaining organoleptic qualities which are acceptable to the consumer.

Surprisingly and unexpectedly, the inventors have developed a food composition having the organoleptic qualities and the rheological properties of a cream pudding, while substituting a large part of the fat with a mixture of milk permeate and vegetable flour. The present invention thus overcomes the abovementioned drawbacks. Indeed, while dispensing with the presence of a very large part of the fat, in particular that contained in milk, the inventors have succeeded in formulating dessert compositions having the same texture and taste properties as a cream pudding.

The present invention thus relates to a food composition comprising, in weight percent relative to the total weight of the composition:
from 0.5% to 5%, preferably from 1% to 2%, more preferably from 1% to 1.5% and even more preferably 1.2% of vegetable flour;
from 6% to 20%, preferably from 6% to 10%, more preferably from 8% to 10%, even more preferably 9.1% of milk permeate;
   characterized in that said composition has a viscosity, measured using the Rheomat RM 200 apparatus at a temperature of 10° C. and at a shearing of 64 s⁻¹, of between 200 and 4000 mPa·s, preferably between 300 and 3700 mPa·s, preferably between 400 and 3000 mPa·s, preferably between 1000 and 2500 mPa·s, even more preferably approximately 2500 mPa·s.

### DEFINITIONS

In the context of the present invention, the term “milk” denotes milk obtained from an animal, for instance cow, goat or ewe. Typically, this term encompasses, inter alia, whole milk, skim milk and semi-skim milk. For the purposes of the invention, this term does not encompass milk permeate.

The term “whole milk” is intended to mean heat-treated milk which, with regard to its fat content, corresponds to one of the following formulae:
standardized whole milk: a milk of which the fat content comes to at least 3.50% by weight for 100 g of final product;
non-standardized whole milk: a milk of which the fat content has not been modified since the milking stage, neither by addition or removal of fats from the milk, nor by mixing with milk of which the natural fat content has been modified. However, the fat content cannot be less than 3.50% by weight for 100 g of final product.

The term “skim milk” is intended to mean heat-treated milk of which the fat content cannot exceed 0.50% by weight for 100 g of final product. Typically, this skim milk can be obtained by centrifugation prior to ultrafiltration.

The term “semi-skim milk” is intended to mean heat-treated milk of which the fat content has been brought back to a content by weight of between 1.50% and 1.80% for 100 g of final product.

The term “cream pudding” is intended to mean milk desserts produced from dairy starting materials which make up at least 20%, in particular at least 50%, of their composition, to which other ingredients (such as rice, semolina, sugar, fruit, caramel, coffee, chocolate, etc.) and additives (such as texturing agents, flavorings, coloring agents, antifungal agents, etc.) have been added. They undergo a cooking, pasteurization or sterilization heat treatment. The term “milk permeate”, or “deproteinated milk” or else “deproteinized milk” is intended to mean the product obtained after removal of the milk proteins and of the dairy fat contained in milk, in particular skim milk and semi-skim milk. Typically, this milk permeate is obtained by passing the milk over microperforated ultrafiltration membranes which hold back all of the protein molecules, while the lactose and the mineral salts pass through the membrane. The standardization of the protein content can be of major importance in the food-processing industry for economic profitability.

Typically, the microperforated membranes hold back molecules having a molecular weight greater than 30 kDa, preferentially 20 kDa, even more preferentially of 10 kDa. This filtration thus prevents the following from passing through:
milk proteins;
viable and non-viable bacteria;
bacterial protein antigens, and
fats.

Thus, the permeate has the advantage of having a fat content which is reduced, compared with the milk, preferentially by approximately at least 20%, 30%, 40%, 50%, 60%, 70%, 80%, more preferentially by 90% and even more preferentially by approximately at least 99%.

Preferably, the milk permeate has a fat content of 0% to 1%, even more particularly of 0% to 0.5%.

The milk permeate can be obtained by drying using a fluidized bed. Thus, in the context of the invention, the expression “milk permeate” encompasses both the milk permeate obtained after passing over microperforated membranes, and also the milk permeate obtained after reconstitution of a dried permeate.

Typically, this permeate can be found commercially, in particular under the tradename Variolac®, sold by the company Arla Foods. Typically, the milk permeate is defined according to its lactose content. Preferentially, said milk permeate can be chosen from Variolac®960 (milk permeate containing 96% of lactose) and Variolac®850 (milk permeate containing 85% of lactose), and mixtures thereof.

These milk permeates can be in powder or liquid form or in the form of a mixture. In one preferred embodiment, the permeate is formulated by mixing powdered permeate and liquid permeate.

The term “dessert-type composition” is intended to mean a food composition according to the invention. Such a composition may be a fresh dairy product, a product with a long shelf life and/or a product which is stable at ambient temperature.

The term “fresh dairy product” is intended to mean fermented dairy products, yogurts, fresh milk desserts, or else fermented milks.

The expression “product with a long shelf life” is intended to mean a product which can be safely stored in a hermetic container that is chilled and/or at ambient temperature for a period of at least 1 month, 6 months, 12 months or 18 months, without deterioration of the product organoleptic qualities.

The expression “cream pudding-type composition” is intended to mean a food composition having the rheological properties and the organoleptic characteristics of a cream pudding. This expression denotes compositions which are not mainly composed of a mixture of whole milk and skim milk, but which nevertheless have rheological properties and organoleptic characteristics similar to cream puddings.

Typically, “the rheological properties of a cream pudding” are defined by the viscosity of the product. This viscosity is preferentially between 1500 and 3000 mPa·s, when it is measured using the Rheomat RM 200 apparatus at a temperature of 10° C. and with a shearing of 64 s⁻¹.

Typically, the “organoleptic characteristics of a cream pudding” encompass a multitude of criteria, such as the spoon impression during tasting of the product, the jellied appearance of the product, the thickness that it confers in the mouth, the strength of the flavor notes and the strength of the dairy notes.

The term “sensory analysis” is intended to mean a technique which makes it possible to describe objectively the organoleptic properties of a product. It is a description of this product, using a set of standardized descriptors, by a group of individuals trained to quantify these, descriptors on an evaluation scale. Typically, the descriptors used for describing a cream pudding-type composition are chosen from:
spoon impression;
jellied appearance;
thickness in the mouth;
strength of the flavor notes; and
strength of the dairy notes.

The term “fat” is intended to mean the fatty substances such as fats or oils contained in the food composition of the invention. The fat content is measured relative to the weight of the food composition of the invention.

The term “cream” is intended to mean the fat resulting from the centrifugal separation or from the skimming of the milk. Typically, during the process for obtaining cream, the milk, which is first heat treated, continuously feeds the skimming machine. It is subjected to very rapid rotation inside a tank. The centrifugal force accelerates the separation of the milk constituents. The heaviest reach the walls, whereas the fatty substances, which are lighter, gather together at the centre: this is the cream. Depending on whether it is taken nearer or further from the axis of rotation, said cream is more or less rich in fats. On leaving the centrifuge, most creams are pasteurized at a temperature of 95 to 98° C. for 30 seconds.

In other words, the cream constitutes the major part of milk fat. It exists in the form of globules dispersed in an aqueous milk phase. The fat globules are surrounded by a membrane consisting of various proportions of proteins, of phospholipids and of glycerides. These very important phospholipids depend on most of the emulsifying properties of the fat globule membrane. The absorption of casein and of proteins inside the aqueous phase of the cream, in the surface of the milk fat globules where the globule membrane is destroyed allows viscosity variability. Casein promotes interaction with other molecules such as calcium, thereby creating a new structure in the cream and, as a direct result, modifies the texture properties.

### Food Composition of the Invention

The invention relates to a food composition comprising, in weight percent relative to the total weight of the composition:
from 0.5% to 5%, preferably from 1% to 2%, more preferably from 1% to 1.5% and even more preferably 1.2% of vegetable flour;
from 6% to 20%, preferably from 6% to 10%, more preferably from 8% to 10%, even more preferably 9.1% of milk permeate;
   characterized in that said composition has a viscosity, measured using a Rheomat RM 200 apparatus at a temperature of 10° C. and with a shearing of 64 of between 200 and 4000 mPa·s, preferably between 300 and 3700 mPa·s, preferably between 400 and 3000 mPa·s, preferably between 1000 and 2500 mPa·s, even more preferably of approximately 2500 mPa·s.

For the purposes of the present invention, the term “shearing” is intended to mean a shear rate advantageously expressed in s⁻¹.

Preferably, the food composition according to the invention is a dessert composition. More preferably, the food composition according to the invention is a cream pudding-type composition.

The food composition of the invention is characterized by the substitution of a part of the milk, more specifically of the milk fat, with a mixture of milk permeate and vegetable flour. Such a substitution makes it possible to reduce the fat content and the protein content of the food composition according to the invention.

The inventors have demonstrated that the cream pudding-type compositions of the invention have the same rheological properties, in terms of viscosity, as cream puddings.

They have also demonstrated, through a sensory analysis study, that the food compositions of the invention have the same organoleptic qualities as a cream pudding.

Preferably, the food composition according to the invention comprises from 1% to 10%, preferably from 5% to 10%; more preferably from 8% to 10%, even more preferably 8.5% of lactose by weight relative to the total weight of the composition

Preferably, the protein content in the food composition of the invention, in weight percent relative to the total weight of the composition, is between 0% and 10%, preferably between 0.1% and 5%, preferably between 0.4% and 1%, more preferably between 0.5% and 0.9%, and even more preferably approximately 0.8%. Preferably, the fat content in the food composition of the invention, in weight percent relative to the total weight of the composition, is between 0% and 20%, preferably between 0% and 10%, more preferably between 0% and 5%, more preferably between 1% and 3%, more preferably between 2% and 3% and even more preferably approximately 2.0%.

Preferably, said food composition is a stable composition.

For the purposes of the present invention, the term “stable composition” is intended to mean a composition having less than 5% by weight of separated liquid phase after 8 weeks at 10° C. relative to the total weight of the composition, advantageously less than 3% by weight. The term “separated liquid phase” is intended to mean the transparent aqueous phase which appears at the bottom or on the composition.

The cream pudding-type compositions according to the invention preferably comprise less than 50% of milk and are characterized by the substitution of a part of the milk, more specifically of the milk fat, with the milk permeate.

Thus, the cream pudding-type composition according to the invention has the following advantages:
it has a reduced fat content compared with a cream pudding, and thus satisfies the requirements of consumers wishing to reduce their fat consumption;
it has the same viscosity as a cream pudding;
it has organoleptic qualities which are similar for the consumer compared with a cream pudding;
it has an improved dairy note sensation owing to the presence of milk permeate; and
it has a reduced-cost formulation owing to the presence of milk permeate.

In one embodiment of the invention, the vegetable flour is chosen from wheat flour, rice flour and corn flour. Typically, the introduction of wheat flour into the food composition of the invention results in the presence of gluten in said composition. On the other hand, the introduction of rice flour and/or corn flour does not result in the presence of gluten. Those skilled in the art will easily be able to choose the vegetable flour of interest according to the requirements of the consumer to be satisfied, in particular in terms of gluten content.

Preferably, the vegetable flour is obtained according to a treatment by partial pregelatinization. Such a process is described in European patent EP 0 105 787, which is incorporated by way of reference. The process for treating a vegetable flour by partial pregelatinization consists in moistening the flour so as to give it a clearly-determined moisture content then in heating it under precise temperature, pressure and time conditions, which can, however, vary according to the nature of the flour used. More specifically, the flour is moistened so as to give it a total moisture content of between approximately 18% and 35%, then steam-heating is carried out for 5 to 50 minutes, and, finally, the flour thus treated is ground and dried. The flour is then generally moistened such that its total moisture content is between 25% and 30%, and then it is spread out before heating onto trays to a layer with a thickness between 1 and 5 cm. The steam-heating can be carried out at normal atmospheric pressure, in saturated steam, for a period of between approximately 20 and 50 minutes. The heating during the treatment in accordance with the process of the invention is such that the temperature in the middle of the flour, measured at the exit of the heating device, is approximately 85 to 90° C. Outside this range, the flour is barely or too pregelatinized. The pregelatinization process can be carried out in the commonly used equipment of the art of the treatment of flour, starch or similar products. For example, the heating can be carried out in an autoclave comprising trays onto which the flour is spread. Likewise, the grinding and the drying are carried out in commonly used pieces of equipment.

The vegetable flour thus obtained has the following characteristics:
it is easily dispersible,
it has a high viscosity,
it has a strong binding capacity after cooking,
it does not exhibit retrogradation,
it is resistant to pH and temperature variations, to freezing/thawing cycles and to shearing during cooking.

Preferably, the vegetable flour is a wheat flour, more preferably a pregelatinized wheat flour.

Even more preferably, the vegetable flour is a wheat flour sold by the company Limagrain under the tradename westhove wheat 1000R.

Alternatively, the vegetable flour is a flour derived from waxy wheat. This waxy wheat has the particularity of containing almost 100% of amylopectin, whereas the more common varieties contain 76% of amylopectins and 24% of amylose, which improves the viscosity of the final product and thus avoids syneresis.

In one embodiment, the food composition of the invention comprises, in weight percent relative to the total weight of the composition:
from 0 to 20%, preferably from 0.1% to 10%, more preferably from 0.5% to 3%, more preferably from 1% to 2%, more preferably approximately 1.20% of milk powder, preferentially of skim milk powder,
from 0 to 5% of cream.

Typically, the food composition of the invention comprises from 20% to 80% of a liquid matrix chosen from water, milk, reconstituted powdered milk, and mixtures thereof.

In one embodiment, the food composition of the invention may also comprise additives, sugar, water, starch and salt.

Typically, the additives are chosen from stabilizers and thickeners, emulsifiers, coloring agents, acidity regulators, and flavorings.

These additives can be used to ensure the stability and the integrity of the emulsion, given the fat content and the durability of the product.

A nonlimiting list of acidity regulators consists of lactic acid, sodium lactate, potassium lactate, calcium lactate, citric acid, calcium citrates, sodium carbonate, sodium bicarbonate, sodium sesquicarbonate, potassium carbonate, or else potassium bicarbonate.

A nonlimiting list of stabilizers or thickeners consists of calcium carbonate, sodium dihydrogen citrate, trisodium citrate, monopotassium citrate, tripotassium citrate, calcium sulfate, monosodium orthophosphate, disodium orthophosphate, trisodium orthophosphate, monopotassium orthophosphate, dipotassium orthophosphate, tripotassium orthophosphate, monocalcium orthophosphate, dicalcium orthophosphate, tricalcium orthophosphate, disodium diphosphate, trisodium diphosphate, tetrasodium diphosphate, tetrapostassium diphosphate, dicalcium diphosphate, diacid calcium diphosphate, pentasodium triphosphate, pentapotassium triphosphate, sodium polyphosphate, potassium polyphosphate, calcium sodium polyphosphate, calcium polyphosphate, ammonium polyphosphate, alginic acid, sodium alginate, potassium alginate, ammonium alginate, calcium alginate, propylene glycol alginate, agar-agar, carrageenan, transformed Eucheuma algae, locust bean gum, guar gum, gum arabic, xanthan gum, gellan gum, pectins, microcrystalline cellulose, powdered cellulose, methylcellulose, hydroxypropylcellulose, hydroxypropylmethylcellulose, methylethylcellulose, sodium carboxymethylcellulose, glycerol esters of diacetyltartaric acid and of fatty acids, potassium chloride, sodium chloride, mono-starch phosphate, distarch phosphate esterified with sodium trimethaphosphate esterified with phosphorus oxychloride, phosphated distarch phosphate, acetylated distarch phosphate, starch acetate esterified with acetic anhydride, acetylated distarch adipate, hydroxypropyl starch, hydroxypropyl distarch phosphate, or else sodium starch octenylsuccinate.

Preferably, said thickener is chosen from xanthan gum, carrageenans, pectins, starch, modified starches, gellan gum, cellulose and its derivatives, and mixtures thereof.

Preferably, said stabilizer or thickener is carrageenan.

A nonexhaustive list of emulsifiers consists of soya lecithin, polyoxyethylene (20) sorbitan monolaurate, polyoxyethylene (20) sorbitan monooleate, polyoxyethylene (20) sorbitan monopalmitate, polyoxyethylene (20) sorbitan monostearate, polyoxyethylene (20) sorbitan tristearate, fatty acid mono- and diglycerides, glycerol esters of acetic acids and of fatty acids, glycerol esters of lactic acids and of fatty acids, glycerol esters of citric acids and of fatty acids, fatty acid sucrose esters, polyglycerol esters of fatty acids, sorbitan monostearate, sorbitan tristearate, sorbitan monolaurate, sorbitan monooleate, or else sorbitan monopalmitate.

The food composition of the invention may also comprise modified starch. Typically, this modified starch is chosen from starch phosphate (E1410), distarch phosphate (E1412), acetylated distarch phosphate (E1414), acetylated starch (E1420), acetylated distarch adipate (E1422), hydroxypropyl starch (E1440), hydroxypropyl distarch phosphate (E1442), sodium starch octenylsuccinate (E1450), or else acetylated oxidized starch (E1451).

A nonexhaustive list of coloring agents consists of riboflavin (E101), quinoline yellow (E104), orange yellow S (E110), azorubine and carmoisine (E122), ponceau 4R and cochineal red A (E124), indigotine, indigo carmine (E132), paprika extract (E160) or else titanium dioxide (E171).

A nonexclusive list of flavorings consists of dark chocolate, milk chocolate, white chocolate, hazelnut, coconut, vanilla, caramel, coffee, speculoos biscuit, salted caramel, praline, pistachio, or else mixtures thereof.

Preferably, the composition of the invention comprises, in weight percent relative to the total weight of the composition:
from 0 and 5% of cream;
from 0 and 5%, preferably from 0.5 and 2%, preferably approximately 1.20% of skim milk powder;
from 5% to 15%, preferably from 9% to 11%, even more preferably approximately 9.1% of milk permeate; and
from 0.5% and 3%, preferably from 1 to 2%, more preferably approximately 1.2% of vegetable flour, preferably of wheat flour, even more preferably of pregelatinized wheat flour.

In one preferred embodiment, said composition also comprises, in weight percent relative to the total weight of the composition:
approximately 0.06% of carrageenans;
approximately 2.5% of modified starch E1442;
from 5% to 14% of sugar, preferably from 9% to 11%, even more preferably approximately 10% of sugar;
from 0 to 1%, preferably approximately 0.7% of cocoa powder; and
from 0 to 1%, preferably approximately 0.2% of chocolate flavoring.

Typically, the protein content of said composition is between 0 and 2%, and is preferably approximately 0.9% in weight percent relative to the total weight of the composition.

Typically, the fat content of said composition is between approximately 0 and 4%, preferably between 1% and 3%, and is even more preferably approximately 2% in weight percent relative to the total weight of the composition.

### FIGURES

FIG. 1: Bar diagram representing the results of the sensory analysis of 2 compositions according to the invention (compositions 1 and 3) compared with compositions not comprising milk permeate (compositions 2 and 4).

The criteria studied are the following:
spoon impression;
jellied appearance;
thickness in the mouth,
strength of the chocolate notes; and
strength of the dairy notes.

### EXAMPLES

### I. Compositions

The inventors developed 4 compositions having the following formulations (the percentages refer to the weight percentages relative to the total weight of the composition). Compositions 1 and 3 comprise milk permeate (sold under the name Variolac by the company Arla), respectively in combination with wheat flour (Wethove wheat 1000R and the standard commercial flour T55).

Compositions 2 to 4, for their part, comprise lactose, respectively in combination with wheat flour (Wethove wheat 100R and the T55 flour).

Finally, the last composition corresponds to a conventional cream pudding of the prior art, which can be found on the market, in particular under the tradename Danette® from the company Danone. This product comprises a much higher amount of fat than compositions 1 to 4, as in the table hereinafter.

The various compositions are iso-lactose (8.5%).

The contents are expressed in percent, relative to the total weight of the composition.

| | Composition 1: | Composition 2: | | | |
|---|---|---|---|---|---|
| | wheat flour | wheat flour | | | |
| | (Westhove wheat | (Westhove wheat | Composition 3: | Composition 4: | Prior art cream |
| | 1000R) and | 1000R) and | T55 flour and | T55 flour and | pudding |
| | permeate | lactose | permeate | lactose | composition |
| Cream 40 g/kg | 4.82 | 4.82 | 4.82 | 4.82 | 9.25 |
| Skim milk | 1.20 | 1.99 | 1.20 | 1.99 | 6.20 |
| powder | | | | | |
| Modified starch | 2.50 | 2.5 | 2.50 | 2.50 | 2.50 |
| E1442 | | | | | |
| Sugar | 10.00 | 10.0 | 10.00 | 10.00 | 14.5 |
| Ultrafiltration | 9.13 | 0.0 | 9.13 | 0.00 | 0.0 |
| permeate | | | | | |
| (Variolac 850) | | | | | |
| Cocoa | 0.72 | 0.72 | 0.72 | 0.72 | 1.70 |
| Chocolate | 0.17 | 0.17 | 0.17 | 0.17 | 0.15 |
| flavoring | | | | | |
| Pregelatinized | 1.21 | 1.21 | 0.00 | 0.00 | 0.0 |
| wheat flour | | | | | |
| T55 wheat flour | 0.00 | 0.0 | 1.21 | 1.21 | 0.0 |
| Lactose | | 7.59 | | 7.59 | |
| Carrageenan | 0.06 | 0.06 | 0.06 | 0.06 | 0.05 |
| Water | 70.19 | 70.94 | 70.19 | 70.94 | 65.85 |
| Protein content | 0.8 | 0.8 | 0.8 | 0.8 | 2.4 |
| (%) | | | | | |
| Fat content (%) | 2.0 | 2.0 | 2.0 | 2.0 | 2.4 |

Among these compositions, only compositions 1 and 3 are according to the invention.

### II. Rheological Properties of Compositions 1 to 4

The inventors measured the viscosity of each composition after one week of storage.

These viscosities were measured using the Rheomat RM 200 apparatus at a temperature of 10° C. and with a shearing of 64 They also measured the pH of each of these compositions.

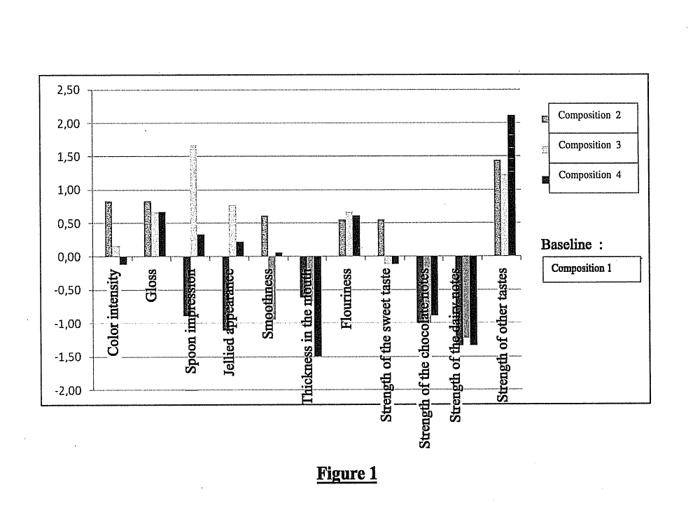

The results are represented in FIG. 1:

| | Compo- | Compo- | Compo- | Compo- | Reference |
|---|---|---|---|---|---|
| | sition 1 | sition 2 | sition 3 | sition 4 | composition |
| Viscosity | 3624 | 990 | 2213 | 1794 | 2500 |
| (mPa · s) | | | | | |
| pH | 6.25 | 6.82 | 6.23 | 6.96 | 6.70 |
| Solids % | 28.5 | 27.1 | 26.7 | 30.9 | 31.00 |

The rheological properties of compositions 1 and 3, comprising milk permeate in combination with wheat flour (westhove wheat 1000R from Limagrain or T55 commercial wheat flour), are rheological properties similar to that of the reference composition (cream dessert).

### II. Sensory Analysis

The inventors tested the sensory properties of compositions 1 to 4 using the following descriptors:
spoon impression
jellied appearance
thickness in the mouth
strength of the chocolate notes
strength of the dairy notes.

FIG. 1 sums up the results of this study. These results show that the composition according to the invention, comprising Limagrain wheat flour and milk permeate, exhibits:
a better dairy note strength;
a better chocolate taste strength;
a better spoon impression and
a better thickness in the mouth.

The inventors have thus demonstrated that the substitution of dairy fats with a mixture of milk permeate and vegetable flour makes, it possible to maintain the organoleptic characteristics of the product, in particular in comparison with a cream pudding.

What is claimed is:

1. A food composition comprising, in weight percent relative to the total weight of the composition:
from 0.5% to 5% of vegetable flour;
from 6% to 20% of milk permeate;
characterized in that said composition has a viscosity, measured using the Rheomat RM 200 apparatus at a temperature of 10° C. and with a shearing of 64 s⁻¹, of between 200 and 4000 mPa·s.

2. The composition as claimed in claim 1,
characterized in that it also comprises from 1% to 10% weight percent relative to the total weight of the composition of lactose.

3. The food composition as claimed in claim 1 or 2,
characterized in that the fat content, in weight percent relative to the total weight of the composition, is between 0% and 20%.

4. The food composition of claim 1, characterized in that the protein content, in weight percent relative to the total weight of the composition, is between 0% and 10%.

5. The composition of claim 1, characterized in that said vegetable flour is chosen from the group consisting of wheat flour, rice flour and corn flour.

6. The composition of claim 1, characterized in that said vegetable flour is a pregelatinized vegetable flour.

7. The composition as claimed in claim 1, said composition also comprising:
from 0 to 20% weight percent relative to the total weight of the composition of skim milk powder,
from 0 to 5% weight percent relative to the total weight of the composition of cream.

8. The composition of claim 1, said composition also comprising additives, sugar, water, starch or salt.

9. The composition as claimed in claim 8, characterized in that said additives are chosen from stabilizers and thickeners, emulsifiers, coloring agents, acidity regulators, and flavorings.

10. The composition as claimed in claim 9, characterized in that said thickener is chosen from xanthan gum, carrageenans, pectin, starch, modified starches, gellan gum, cellulose and its derivatives, and mixtures thereof.

11. The composition of claim 10, characterized in that the thickener content is between 1% and 5% weight percent relative to the total weight of the composition.

12. The composition of claim 1, characterized in that it comprises, in weight percent relative to the total weight of the composition:
from 0 and 5% of cream;
from 0 and 5% of skim milk powder;
from 5% to 15% of milk permeate; and
from 0.5% and 3% of vegetable flour.
